(19) United States
(12) Patent Application Publication
(10) Pub. No.: US 2005/0147632 A1
(43) Pub. Date: Jul. 7, 2005

(54) Virally infected plants as a source of insect reppellants/attractents

(76) Inventors: Nitzan Paldi, Ha'Ela (IL); Eri M. Govkin, Jerusalem (IL); Herve Huet, Yahud (IL); Gai Yarden, HaNegev (IL)

Correspondence Address: Martin Moynihan;Anthony Castorina, Suite 207, 2001 Jefferson Davis Highway, Arlington, VA, 22202, US

(21) Appl. No.: 10/510,753

(22) PCT Filed:
(86) PCT No.: PCT/IL03/00306

Related U.S. Application Data
(60) Provisional application No. 60/371,430, filed on Apr. 11, 2002.

(51) Int. Cl. A01N 63/00; A01N 25/00; A01N 65/00

(52) U.S. Cl. 424/405; 424/93.6; 424/725

(57) ABSTRACT

A method of uncovering a putative insect repellent or attractant is provided. The method is effected by identifying volatiles differentially emitted from a plant infected with a virus and identifying at least one of the volatiles thereby uncovering the putative insect repellent or attractant.

### FIELD AND BACKGROUND OF THE INVENTION

The present invention relates to volatiles emitted from virally infected plants, and to the use thereof as insect repellents and/or attractants.

Plant and insect interactions may be economically undesirable, as for example in the case of herbivorous or pathogen-transmitting insects (agricultural pests). Control of agricultural pests is typically effected by the use of synthetic toxic pesticides, an approach which has resulted in catastrophic damage to the environment and public health. Accordingly, an increasing public awareness of potential hazards associated with synthetic pesticides release, coupled with increasing regulatory stringency on the use of synthetic pesticides, have prompted a growing demand for alternative pest control agents which are safe and environmentally friendly.

Several naturally occurring volatiles emitted from plants have been described as potential pest repellants. For example, U.S. Pat. No. 5,756,100 describes a pest repellent mixture for application on crops based on red pepper, black pepper and garlic; U.S. Pat. No. 6,524,605 describes plant terpenoids useful for repelling arthropods; U.S. Pat. No. 5,105,622 describes a mixture of natural oils effective in repelling mosquitoes and other insects; while U.S. Pat. No. 5,365,017 discloses a transgenic plant having increased levels of cycloarterol insect repellent.

Naturally occurring volatiles emitted from plants play an important role in plant-insect interactions. For example, certain plants emit volatile repellents which confer resistance to herbivorous insects, while certain herbivorous insects, as well as pollinating insects, are drawn to plants by certain volatile attractants (Pare and Tumlinson, 1999; Arinuma et al., 2000; Ozawa et al., 2000; Kessler and Baldwin, 2001; and Dudareva et al., 1999).

Recently, Eigenbrode et al. (2002) reported that volatiles emitted from potato plants infected with the potato leafroll virus (PLRV) specifically attract and arrest Myzus persicae aphids. The PLRV is principally transmitted by M. persicae in a persistent (circulative) manner. By contrast, plants infected by potato virus X (PVX) which does not require an insect-vector, or by the potato virus Y (PVY) which is transmitted in a nonpersistent manner by several aphid species, did not attract or arrest these aphids. It was thus suggested that that the attraction or arrestment of M. persicae on PLRV-infected plants is adaptive for the aphid because PLRV-infected plants are superior hosts for this insect.

While reducing the present invention to practice, the present inventors have surprisingly discovered that plants infected with viruses which are not persistently transmitted by specific vectors, such as viruses which are typically mechanically transmitted, or viruses which are non-persistently transmitted by a broad range of vector species, may differentially emit volatiles which can function as insect repellents or insect attractants. In addition, the emission of such virally induced insect repellants or attractants is dependant upon the specific combination of plant-virus-insect and the specific stage of plant development and infection.

### SUMMARY OF THE INVENTION

According to one aspect of the present invention there is provided a method of uncovering a putative insect repellent or attractant comprising identifying volatiles differentially emitted from a plant infected with a virus and identifying at least one of the volatiles thereby uncovering the putative insect repellent or attractant.

According to another aspect of the present invention there is provided a method of uncovering a putative insect repellent or attractant which includes infecting a plant with a virus, followed by identifying volatiles differentially emitted from the plant infected with the virus as compared to a non-infected plant at a time point following the step of the infecting said plant with the virus, and finally, identifying at least one of the volatiles thereby uncovering the putative insect repellent or attractant.

According to further features in preferred embodiments of the invention described below, the virus is an insect transmitted virus.

According to still further features in the described preferred embodiments the virus is acquired by the insect in a persistent manner.

According to still further features in the described preferred embodiments the virus is acquired by the insect in a non persistent manner.

According to still further features in the described preferred embodiments the virus is a virulent virus.

According to still further features in the described preferred embodiments the virus is an avirulent virus.

According to still further features in the described preferred embodiments the identifying of the volatiles differentially emitted from the plant infected with the virus is effected by collecting the volatiles emitted from the plant infected with the virus and an identical plant not infected with the virus.

According to still further features in the described preferred embodiments the collecting of the volatiles is effected by adsorbing the volatiles emitted from the plant and the identical plant to a solid adsorbent.

According to still further features in the described preferred embodiments the collecting of volatiles is further effected by desorbing the volatiles from the solid absorbent.

According to still further features in the described preferred embodiments the identifying of the at least one of the volatiles is effected by using a gas chromatograph, a gas chromatograph coupled with a mass spectrograph, or a high pressure liquid chromatograph.

According to still further features in the described preferred embodiments the volatiles differentially emitted from a plant infected with a virus include volatiles emitted at a higher level as compared with the identical plant.

According to still further features in the described preferred embodiments the volatiles differentially emitted from a plant infected with a virus include volatiles emitted at a lower level as compared with the identical plant.

According to still further features in the described preferred embodiments the volatiles differentially emitted from a plant infected with a virus include volatiles unique to the plant infected with the virus.

According to still further features in the described preferred embodiments the volatiles differentially emitted from a plant infected with a virus is effected at a predetermined time point following infection of the plant with the virus.

According to still further features in the described preferred embodiments the predetermined time point corresponds to a predetermined titer of the virus in a tissue of the plant.

According to still further features in the described preferred embodiments the uncovering of a putative insect repellent or attractant further comprising monitoring a behavior of a plurality of insects exposed to the at least one of the volatiles.

According to still further features in the described preferred embodiments the monitoring is effected by enumerating the plurality of insects attracted or repelled by the at least one of the volatiles.

According to still further features in the described preferred embodiments the enumerating is effected by trapping.

According to still further features in the described preferred embodiments the monitoring is effected by using an insect olfactometer.

According to still further features in the described preferred embodiments the uncovering of a putative insect repellent or attractant further comprising isolating the at least one of the volatiles.

According to still further features in the described preferred embodiments the pest is an insect or a mite.

According to still further features in the described preferred embodiments the pest is a virus transmitting insect.

According to still further features in the described preferred embodiments the characterizing of the volatiles is effected by using a gas chromatograph, a gas chromatograph coupled with a mass spectrograph, or a high pressure liquid chromatograph.

According to still further features in the described preferred embodiments the characterizing of the volatiles further comprising detecting at least one of the volatiles being differentially emitted by the virally infected plant.

The present invention successfully addresses the shortcomings of the presently known configurations by providing methods of uncovering volatiles differentially emitted from virus infected plants and of methods of utilizing such volatiles and methods of isolating polynucleotides encoding regulating biosynthesis of the volatiles.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-f illustrate theoretical changes in attraction of virus transmitting aphids to plants at different growth stages and different virus titers. FIG. 1a illustrates exposure of a non-infected plant to virus-infested aphids. Under this situation the aphids-plant attraction increases over time due to a release of volatiles by the non-infected plant. FIG. 1b illustrates a non-infected plant exposed to non-infested aphids. Under this situation aphids are attracted to volatiles emitted from the non infected plant. FIG. 1c illustrates exposure of plant infected with an avirulent virus to virally infested aphids. Under this situation the aphids-plant attraction decreases over time due to a release of volatiles by the plant infected with the avirulent virus. FIG. 1d illustrates exposure of a plant infected with an avirulent virus to non-infested aphids. Under this situation the plant-aphids attraction gradually increases then gradually decreases by volatiles emitted from the plant infected with the avirulent virus. FIG. 1e illustrates exposure of a plant infected with a virulent virus to virally infested aphids. Under this situation the aphids-plant attraction rapidly decreases due to volatiles emitted from the plant infected with the virulent virus. FIG. 1f illustrates exposure of a plant infected with a virulent virus to non-infested aphids. Under this situation the aphids-plant attraction rapidly increases then rapidly decreases due to volatiles emitted from the plant infected with the virulent virus.

FIG. 2 illustrates a system for collecting headspace volatiles emitted from a plant. The system allows forcing of charcoal-purified air into a glass chamber containing the plant and trapping of the headspace volatiles by a PorpakQ™ absorbent.

FIG. 3 illustrates an insect olfactometer system which compares aphids attraction to, or repulsion from, a test plant (1) and a reference plant (2). The olfactometer includes an aphid chamber connected to two tunnels, one leading to the test plant and the other leading to the reference plant. Charcoal-purified air is forced into the system (in the direction indicated by arrows) and aphids moving towards each plant are captured in aphid traps (marked in dotted lines) and counted.

FIGS. 4a-f are gas chromoatograms illustrating two specific fractions (marked with arrows) of headspace volatiles differentially emitted from virally infected tomato plants. FIG. 4a illustrates headspace volatiles of a mock-infected plant collected one week following treatment. FIG. 4b illustrates headspace volatiles of a similar mock-infected plant but collected two weeks following treatment, indicating a slight decrease in the levels of both specific fractions, as compared with FIG. 4a. FIG. 4c illustrates headspace volatiles of a plant infected with an avirulent PVY strain collected one week following infection, indicating a marked increase of the second fraction (right arrow), as compared with FIG. 4a, while the first fraction (left arrow) was not detected. FIG. 4d illustrates headspace volatiles of a plant infected with an avirulent PVY collected two weeks following infection, showing an increase of the first fraction (left arrow) and a decrease of the second fraction (right arrow), as compared with FIG. 4c. FIG. 4e illustrates headspace volatiles of a plant infected with a virulent PVY collected one week following infection, the results are similar to those shown in FIG. 4c. FIG. 4f illustrates headspace volatiles of a plant infected with a virulent PVY and collected two weeks following infection, indicating marked increases of both specific fractions, as compared with FIG. 4e.

FIG. 5 is a graph illustrating repulsion of aphids (Myzus persicae) by a CMV infected tobacco plant. The graph shows that the number of aphids captured in the olfactometer tunnel leading to the CMV infected plant was substantially lower than the number of aphids captured in the tunnel leading towards an identical non-infected plant, indicating a repulsion of aphids by volatiles emitted by the CMV infected plant.

FIG. 6 is a graph illustrating attraction of aphids (Myzus persicae) to a PVY infected tomato plant. The graph shows that the number of aphids captured in the olfactometer tunnel leading to the PVY infected plant (4 weeks after inoculation) was substantially higher than number of aphids captured in the tunnel leading to an identical non-infected plant, indicating an attraction of aphids to volatiles emitted by the PVY infected plant.

FIG. 7 is a graph illustrating the lack of attraction of aphids (Myzus persicae) to a PVY infected tomato plant 8 weeks following inoculation. The graph shows that the number of aphids captured in the olfactometer tunnel leading to the PVY infected plant (8 weeks after inoculation) was similar to the number of aphids captured in the olfactometer tunnel leading towards an identical non-infected plant.

### DESCRIPTION OF THE PREFERRED EMBODIMENTS

The present invention is of methods of uncovering volatiles differentially emitted from virus infected plants and of methods of utilizing such volatiles as insect repellant or attractants.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Volatiles differentially emitted from virus infected plants were first reported by Shulaev et al. (Nature 385: 718-721, 1997) describing methyl salicylate being differentially emitted by plants infected with tobacco mosaic virus (TMV). This volatile was found capable of inducing plant pathogen resistance in neighboring plants. Recently, Eigenbrode et al. (2002) reported that potato plants infected with the potato leafroll virus emitted volatiles capable of attracting virus transmitting aphids (Myzus persicae) and that potato plants infected with a mechanically transmitted virus (potato virus X) or a nonpersistent insect-transmitted virus (potato virus Y) did not attract the aphids. Eigenbrode et al. did not suggest that virally infected plants may differentially emit volatiles repelling insects, nor did they describe or suggest any methods of practically utilizing volatiles differentially emitted from virally infected plants.

Although Eigenbrode et al. presented important findings with respect to plant-virus and plant viral vector interactions, their study uncovered only one aspect of the mechanism underlying such interactions.

The present inventors propose that interactions between a virus, its insect vector and an infected plant are far more complex and dynamic than that proposed by Eigenbrode et al.

The theory of natural selection predicts that a trait that confers increased fitness will perpetuate in the population, whereas decreased fitness traits will ultimately be discarded. Hence, viruses could have evolved to acquire a trait or traits which confer a competitive advantage. Such a trait or traits enable the virus to manipulate their host plant to release specific chemicals capable of affecting the behavior and activity of the virus vector, other pests, or other plants in their environment.

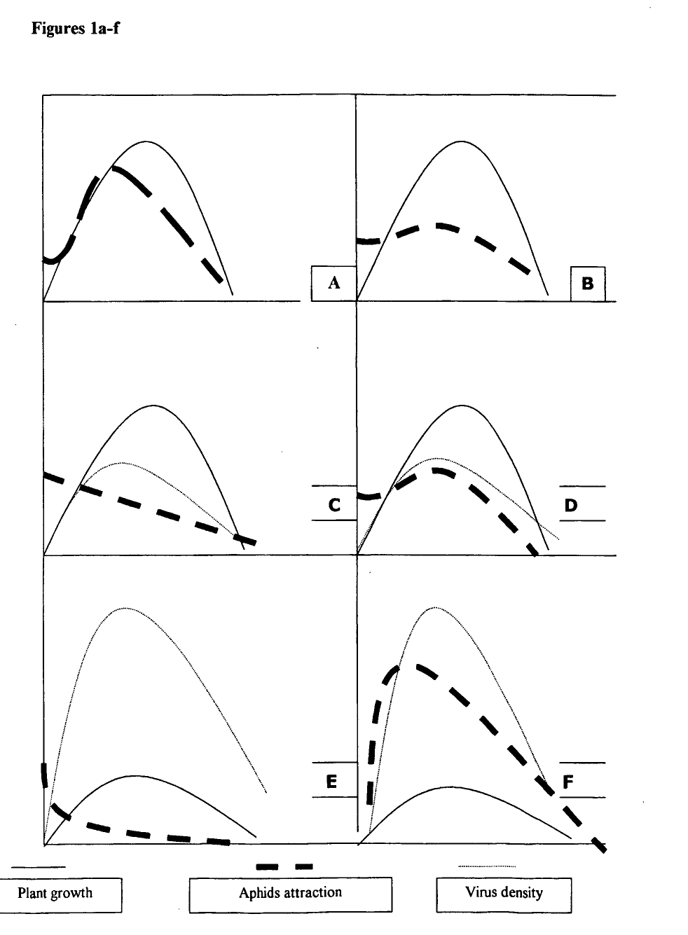

Accordingly, FIGS. 1a-f illustrate theoretical plant volatile emission at various time points following infection with a virus and at various stages of infected plant development. As illustrated by these Figures, the present inventors propose that plant viruses are capable of inducing emission of specific volatiles from infected plants, the quality and quantity of which, change with changes in plant growth state or vigor and/or with virus titers in plant tissues.

As is further described hereinbelow, a specific volatile fraction collected, for example, at a specific time point following infection can function as an insect attractant or repellant, depending on the viral state at that time point. Thus, the composition or level of the released volatiles can change in order to suit the survival need of the virus, either attracting an insect vector in cases where a potential for viral spread is high or repelling viral vectors in cases where a potential for viral spread is low, or in cases where viral vectors can introduce competing viruses into infected plants.

Thus, according to one aspect of the present invention there is provided a method of uncovering a putative insect repellent or attractant.

As used herein the phrase “insect repellent” refers to a molecule which is capable of partially or completely repelling at least one insect species, such as a virus transmitting insect or an insect species classified as a pest.

As used herein the phrase “insect attractant” refers to a molecule which is capable of partially or completely attracting at least one insect species. Such an attraction can at times lead to an arrest in insect movement and fixation of the insect to the source of the attractant.

The method according to this aspect of the present invention is effected by identifying volatiles differentially emitted from a plant infected with a virus and identifying at least one of the volatiles.

Identification of volatiles differentially emitted from infected plants is preferably effected by comparing the volatiles emitted from the infected plant to that emitted from an identical, non-infected plant. Approaches which can be utilized for collection and identification of volatiles differentially emitted from an infected plant are described hereinbelow and in the Examples section which follows.

The phrase “virus” as used herein refers to a virus capable of establishing and propagating within a plant, either locally i.e., within a limited part of the plant, or systemically, i.e., throughout the plant body. There are currently over 500 known viruses capable of infecting almost all plants, example of which are described by Agrios, G. N. (Plant Pathology 3^{rd} Ed., Academic Press, New York, 1998). Viruses are transmitted from plant to plant mechanically through sap, by vegetative propagation, by seed, by pollen or by a vector. Virus transmitting vectors include insects, mites, nematodes, odder and fingi. The most common means of transmission of viruses in the field is by insect vectors, such as aphids, leafhoppers, white flies, mealy bugs, scale insects, treehoppers, true bugs, thrips, beetles and grasshoppers. Generally viruses are carried by insects superficially in a non-persistent manner. However, certain viruses may be transmitted in a persistent manner and accumulate within tissues of the insect vector prior to being introduced into another plant.

The most important insect vectors are aphids and leafhoppers which can transmit over 210 known plant viruses. As a rule, a plurality of insect species can transmit a single nonpersistent virus, and a single insect species can transmit several non-persistent viruses. In the case of viruses transmitted in a persistent manner, the vector-virus relationship is often highly specific. Nonpersistent viruses are generally acquired by insects feeding on an infected plant within a few seconds and can only be transmitted to another plant within several hours. On the other hand, persistent viruses can only be transmitted several hours following acquisition by the insect vector, but they can be transmitted for many days following.

A plant virus may be of a virulent or an avirulent type. A virulent virus is capable of causing a disease accompanied by obvious symptoms. The most common symptom produced by virus infection is reduced growth rate of the plant, mosaic, ring spots, leaf roll, yellowing, streaking, pox formation, tumor formation, and pitting.

An avirulent virus is incapable of causing a disease accompanied by obvious symptoms. Viruses often infect plants without ever causing development of obvious symptoms. Such symptomless infections can result from infection of a tolerant plant host variety or cultivar, or use of a genetically impaired or attenuated virus strain.

As is mentioned hereinabove, identification of volatiles which are differentially emitted from virus infected plants is preferably effected by collection and characterization of a volatile fraction or fractions unique (in volatile composition or volatile levels) to infected plants.

Infected plants may be field infected plants (naturally infected) which are collected for analysis or preferably plants which are deliberately infected using mechanical inoculation or vector aided inoculation approaches. In a preferred mechanical inoculation procedure, tissues of an infected plant believed to contain a high concentration of the virus, preferably young leaves and flower petals, are ground in a buffer solution, preferably phosphate buffer solution, to produce a virus infected sap. The sap is then applied to the surface of healthy plant tissues, preferably leaves, previously dusted with an abrasive such as Carborundum. Application of the sap is preferably made by gently rubbing the leaves with a pad dipped in the sap, with a finger, a glass spatula, a painter's brush, or with a small sprayer. Further preferably, the virus infected sap is applied onto plants by using a high pressure outlet (Gal-On et al., 1995). In successful inoculation, the virus enters the plant cells through the wounds made by the abrasive or through other opening and initiates an infection.

For vector aided inoculation, virus infected plants are exposed to compatible virus-free vectors in a closed cage. The vectors are allowed to feed on the virus infected plant for a time period sufficient to acquire the virus. The virus infected insects are then placed on uninfected plants positioned in a closed cage, and allowed to feed for a time period sufficient to infect the plants.

Headspace volatiles emitted from infected and non-infected (control) plants can be collected and analyzed using several approaches. For example, U.S. Pat. Nos. 5,369,978 and 6,354,135 describe systems for collecting and analyzing aroma chemicals emitted from living plant tissues. Matich et al., (Anal. Chem. 8: 4114-4118, 1996) and Mookherjee et al., (Perfumer and Flavorist 23: 1-11. 1998) describe highly sensitive solid phase micro-extraction (SPME) procedures for “instant” quantitative sampling of plant headspace volatiles. These techniques require placing a single needle in a close proximity to the aroma emitting source for a short period of time, then analyzing the aroma molecules adsorbed onto the needle-like glass fiber by GC/MS.

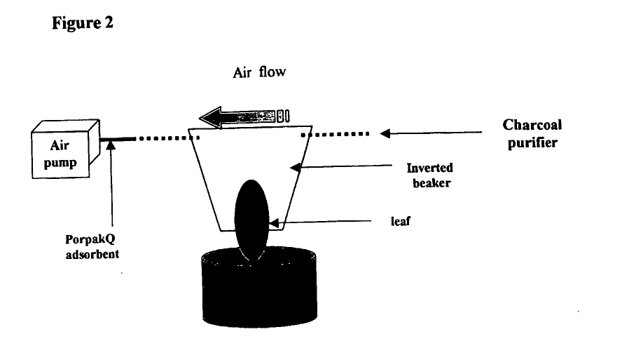

Preferably, collection of volatiles emitted from plants is performed using the procedure described by Pichersky et al. (1994) (illustrated in FIG. 2). Briefly, a plant is placed inside a glass chamber and volatiles emitted from the plant are collected by continuously purging charcoal-purified air inside the chamber and trapping the plant headspace volatiles by a solid absorbent, preferably a solid absorbent, more preferably a polymer absorbent such as, but not limited to, Porpak-Q™, Tenax™, or Hysep™. After a predetermined period of time, the volatiles bound to the adsorbent are desorbed from the solid absorbent with an organic solvent such as, but not limited to, methanol, ethanol, hexane or dichloromethane. The collected volatiles are then identified preferably by way of analysis using a high pressure liquid chromatograph (HPLC), more preferably by using a gas chromatograph (GC), most preferably by using a gas chromatograph couples with mass spectrograph (GC/MS), using procedures well known in the art. The identified volatiles are preferably isolated by way of separating the volatiles by using a GC or by using an HPLC, using procedures well known in the art.

Preferably, volatiles are collected at different time points following infection, at various growth stages of the infected plant or at stages in which predetermined viral titers are present in the infected plant tissue.

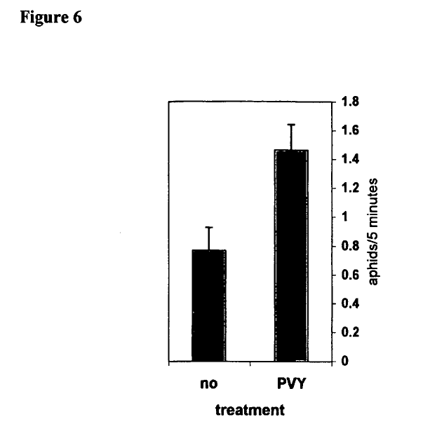

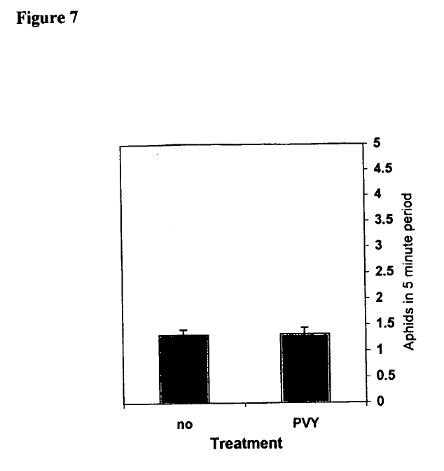

As is mentioned hereinabove, the insect attraction/repulsion to a vitally infected plant may change substantially during different stages of plant development and infection (illustrated in FIGS. 6 and 7). While PVY infected tomato plant effectively attracted aphids 4 weeks after infection (FIG. 6) the infected plants no longer attracted aphids 4 weeks later (FIG. 7). Hence, because of the dynamic nature of virus-plant-insect interactions, the tests determining insect attraction/repulsion to virally infected plants are preferably performed on volatile fractions which are collected at different time points following infection or at various virus titers.

Thus, according to one preferred embodiment of the present invention, headspace volatiles are collected (as described hereinabove) at several time intervals following infection. The time intervals are preferably predetermined based on empirically fixed periods (e.g., daily, weekly), plant development stages (e.g., seedling, maturity, flowering, fruit setting, etc.), or viral infection stages (e.g., titer). The particular choice of time intervals may also take into consideration the specific virus virulence to the specific plant host, and conducted accordingly on a case by case basis. For example, a plant which is infected with a mildly virulent virus is expected to gradually become less attractive to insect vectors (as illustrated in FIG. 1c). Accordingly, the collection of headspace volatiles emitted from such a plant is preferably performed at infrequent and even time intervals. On the other hand, a plant which is infected with a virulent virus is expected to rapidly increase emission of repellents or attractants, while quickly reducing plant vigor (illustrated in FIGS. 1e-f). Accordingly, the collection of headspace volatiles emitted from such a plant is preferably performed at frequent time intervals thus enabling collection of critical peaks of emitted volatiles. Determining time points and time periods (over which collection is effected) may further be guided by monitoring the virus titer in plants (e.g., titer peaks and titer increase or decrease), using conventional virus analytical tests such ELISA kits commercially available from Agdia Inc., Indiana, USA; Agri Analysis Associates, CA, USA; or Adgen Diagnostic System, UK.

Once specific volatile fractions are identified, comparison of such fractions collected from infected and non-infected plants yields the fractions differentially emitted from infected plants.

Such differentially emitted fractions can be characterized by the level of emitted volatiles (higher or lower than that of identical volatiles emitted by non infected plants), by unique volatiles or by a combination of both.

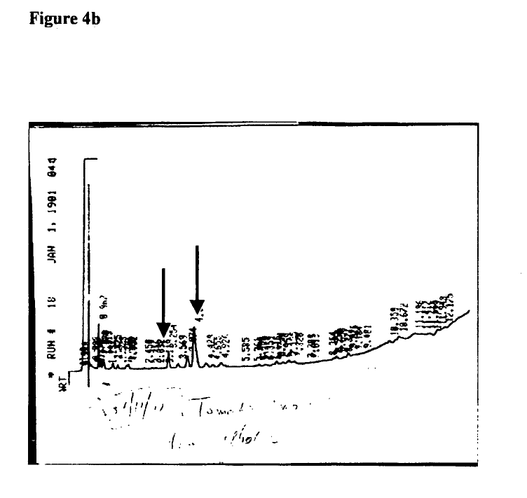

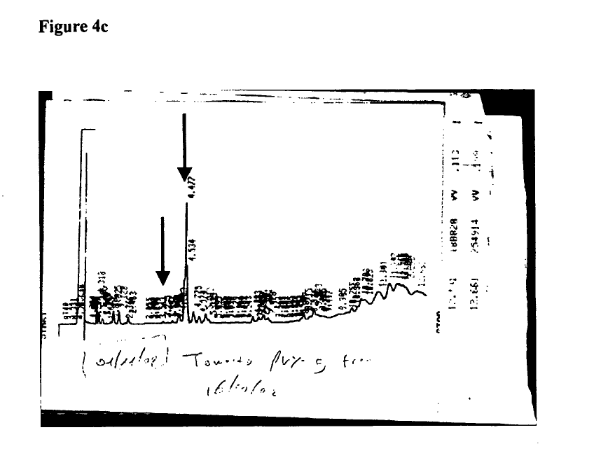

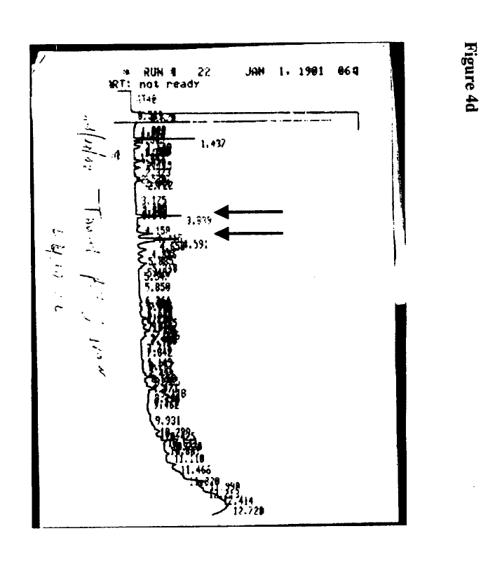

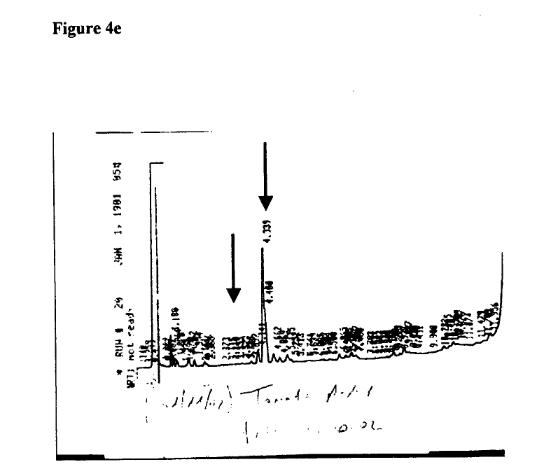

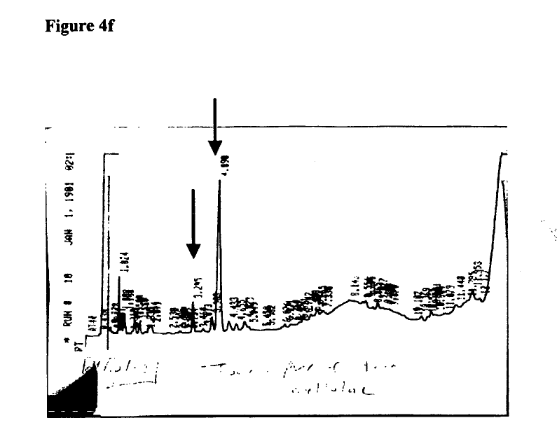

As is illustrated by the Examples provided hereinbelow, the present inventors have uncovered several volatile fractions which are differentially emitted by infected plants. The right arrow of FIG. 4e identifies a volatile fraction emitted by a tomato plant infected with a virulent strain of potato virus Y (PVY). Emission levels of volatiles of this specific fraction were substantially higher in the infected plant as compared with an identical non-infected (mock-infected) plant (illustrated in FIG. 4a by the peak marked with a right arrow). The left arrow of FIG. 4e identifies a volatile fraction emitted by the infected tomato plant. Emission levels of volatiles of this specific fraction were substantially higher in the infected plant as compared with the non-infected plant of FIG. 4a (left arrow).

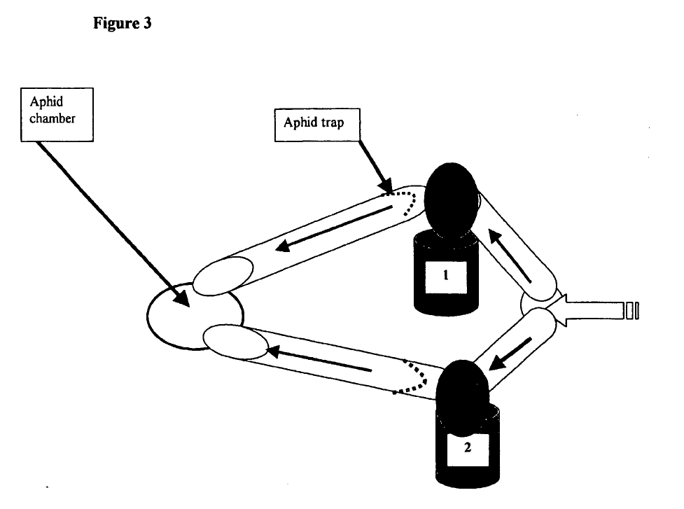

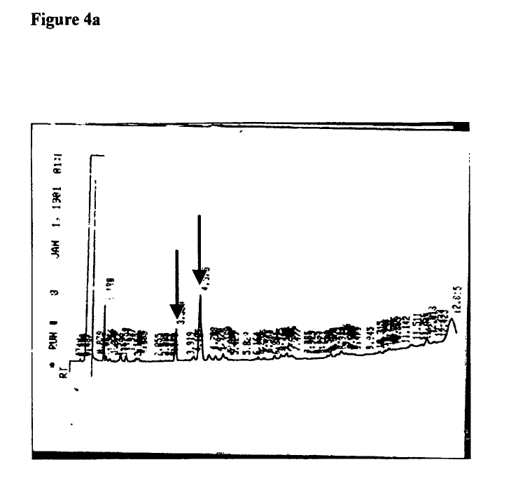

Once identified, volatiles or volatile fractions are further characterized for their ability to attract or repel insects. Such characterization can be effected using several approaches. Preferably, the behavior of insects exposed to plant emitted volatiles is monitored by exposing insects to the plant and measure the relative attraction, or repulsion, of specific insects to specific plants or other volatile-emitting sources. The attraction, or repulsion, of insects to volatiles is preferably monitored with an insect olfactometer system. A suitable insect olfactometer system may be, for example, the open Y-track olfactometer modified after Dickens J. C. (Agricultural and Forest Entomology 1: 47-54, 1999), or the dual-port olfactometer, illustrated and described in detail by Posey et al. (J. Med. Entomol. 35: 330-334, 1998). Preferably, the insect olfactometer is a four tunnel system modified after Brikett et al. (2000) and illustrated in FIG. 3. Briefly, the olfactometer includes a glass chamber into which insects are introduced. The insect chamber is open to two tunnels each leading to another chamber into which a sample of volatiles or a volatiles-emitting plant is placed. Each of these chambers is further connected to another tunnel which supplies a flow of charcoal-purified air. Insects are allowed to move freely from the first chamber into either tunnel and are then trapped deep inside the tunnel. The number of insects trapped in one tunnel within a given time period is compared with the number of insects trapped in the other tunnel. The relative numbers of trapped insects indicate the relative levels of insect attraction/repulsion to or from the respective volatile emitting source.

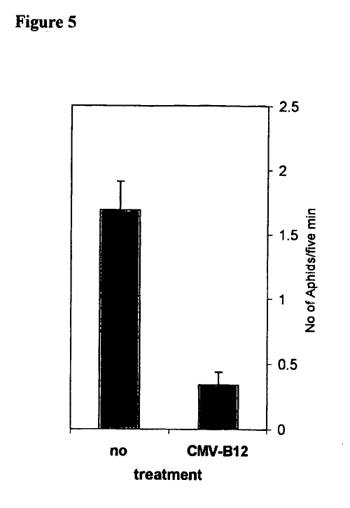

Accordingly, an attraction/repulsion of an insect to a virally infected plant can be determined by introducing the virally infected plant, and an identical non-infected plant, to an olfactometer system and monitoring the relative numbers of insects being trapped in the two tunnels. Example 2 of the Examples section that follows illustrates a CMV infected tobacco plant which attracted a substantially lower number of aphids as compared with a non-infected plant (FIG. 5), thereby indicating insect repulsion. On the other hand, a PVY infected tomato plant attracted a substantially higher number of aphids as compared with a non-infected plant (FIG. 6), thereby indicating insect attraction.

Similarly, the capacity of isolated volatiles to attract, or repel, insects can be determined by introducing insects to an olfactometer and exposing them to a sample of an isolated volatile at the end of one tunnel, and to a sample of a known standard volatile at the end of the second tunnel. The relative densities of insects trapped in the tunnels would indicate the respective level of attraction, or repulsion, of the insects to the isolated volatile.

Once characterized, volatiles or volatile fractions which exhibit capabilities of attracting or repelling insects can be used in a variety of applications.

Isolated insect-attracting volatiles may be utilized to control pests, such as insect pests by attracting a target insect to a trap or to a point where it can be destroyed by an insecticide. For example, U.S. Pat. No. 6,074,634 describes the use of attractants to control Heliothis species, such as the corn earworm, and other lepidopteran pest species, using attractant baits. In another example, U.S. Pat. No. 5,683,687 describes using volatile attractants extracted from jasmine and lavender to trap mosquitoes and houseflies. Trapping may also serve as a survey tool of timing application of insecticides such as to lower the amount of ineffectively applied pesticides. Insect attracting volatiles may also be applied to control harmful insects by being broadcasted over small point sources over an infested area to disorient the insects.

Isolated insect repelling volatiles may be utilized to control plant pests, such as but not limited to virus-transmitting insects, herbivorous insects, as well as human and animal pests such as mosquitoes, flies, fleas, ants, cockroaches, termites and so forth. The most common way of applying repellents to control plant pests is by way of broadcasting over target areas, while repellents of human or animal pests are typically applied to the skin and/or clothing. In addition, pest repellents can be applied in a controlled release systems and formulations that slowly and continuously release them into the environment over a period of time measured in months or years. Pest repellent formulations may include microcapsules and granules, such as described by Herbert et al. (Controlled-Release Delivery Systems for Pesticides, New York, N.Y., Marcel Dekker, 1999). Alternatively, the pest repellents can be applied in a sustained manner using devices such as described, for example, in U.S. Pat. Nos. 2,956,073; 3,116,201; 3,318,769; 3,539,465; 3,740,419; 3,577,515; 3,592,210; 4,017,030.

Once specific virally induced insect repellents/attractants are identified, information derived therefrom can be utilized to identify biosyntheitc enzymes or other polypeptides which participate in, or regulate the biosynthesis of these volatiles or intermediates compounds thereof. Such polypeptides and/or the polynucleotides encoding such polypeptides can be identified and isolated using methods well known in the art of molecular biology. Methods of isolating plant polynucleotides encoding enzymes regulating volatile biosynthesis are described in, for examples U.S. Pat. Nos. 5,849,526 and 5,871,988; Dudareva et al (Plant J. 14: 297-304, 1998); Wang and Pichersky (Arch Biochem. Biophys. 349: 153-160, 1998); Ross et al. (Arch. Biochem. Biophys. 367: 9-16, 1999); and Murfitt et al. (Arch. Biochem. Biophys. 382: 145-151).

Hence, the present invention provides methods of utilizing virally infected plants as a source of insect repellents and/or attractants, and of methods of identifying specific volatiles or volatile fractions which can be used as insect repellants or insect attractants.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

Generally, the nomenclature used herein and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Md. (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Current Protocols in Immunology” Volumes 1 μl Coligan J. E., ed. (1994); Stites et al. (eds), “Basic and Clinical Immunology” (8th Edition), Appleton & Lange, Norwalk, Conn. (1994); Mishell and Shiigi (eds), “Selected Methods in Cellular Immunology”, W. H. Freeman and Co., New York (1980); available immunoassays are extensively described in the patent and scientific literature, see, for example, U.S. Pat. Nos. 3,791,932; 3,839,153; 3,850,752; 3,850,578; 3,853,987; 3,867,517; 3,879,262; 3,901,654; 3,935,074; 3,984,533; 3,996,345; 4,034,074; 4,098,876; 4,879,219; 5,011,771 and 5,281,521; “Oligonucleotide Synthesis” Gait, M. J., ed. (1984); “Nucleic Acid Hybridization” Hames, B. D., and Higgins S. J., eds. (1985); “Transcription and Translation” Hames, B. D., and Higgins S. J., eds. (1984); “Animal Cell Culture” Freshney, R. I., ed. (1986); “Immobilized Cells and Enzymes” IRL Press, (1986); “A Practical Guide to Molecular Cloning” Perbal, B., (1984) and “Methods in Enzymology” Vol. 1-317, Academic Press; “PCR Protocols: A Guide To Methods And Applications”, Academic Press, San Diego, Calif. (1990); Marshak et al., “Strategies for Protein Purification and Characterization—A Laboratory Course Manual” CSHL Press (1996); all of which are incorporated by reference as if fully set forth herein. Other general references are provided throughout this document. The procedures therein are believed to be well known in the art and are provided for the convenience of the reader.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below.

### Example I

### Identification of Volatiles Differentially Emitted from Virus Infected Plants

Materials and Methods

Viruses: Two isolates of Potato Virus Y (PVY) were used: an avirulent Swiss Potato Isolate (SPI), and a virulent Tomato Isolate (TI). Analyses by RT-PCR and ELISA showed that the SPI isolate was capable of causing slow, low level, systemic infection in tomato plants but was incapable of causing symptoms. On the other hand, isolate TI was found capable of causing a systemic infection and severe disease symptoms.

Plants: Virus free tomato plants (Lycopersicom lycopersicum var. Moneymaker) were planted in clean pots filled with commercial peat-based potting mixture (Ilanit, Israel) and were maintained in a greenhouse at 18° C.

Virus inoculation: A virus-infested leaf tissue was ground by pestle and mortar in a 1:4 dilution of 0.05 M ice cold phosphate buffer, pH 7.0, to produce a virus infected sap. The sap was rubbed with a cotton swab onto Carborundum treated leaves of virus free plants. For mock-inoculation, a sterile phosphate buffer was similarly rubbed onto Carborundum treated leaves of virus free plants.

Headspace volatiles collection: Volatiles emitted from infected or non-infected plants were collected according to the procedure described by Pichersky et al. (1994) and as illustrated in FIG. 2. Briefly, an intact plant was enclosed in a glass chamber. Charcoal-purified air was drawn through the chamber for 24 hours, exiting through a trap containing a PorpakQ™ absorbent. The collected volatiles were subsequently eluted from the PorpakQ™ absorbent with hexane solution and analyzed by a gas chromatograph.

Gas chromatograph analysis: Each elutant was injected onto a Hewlett-Packard gas chromatograph having a DB-5 capillary column.

Results

Virus infected plants emitted substantially higher levels of specific volatiles as compared with non-infected (mock-infected) plants. Accordingly, one week following inoculation, gas chromatograms of volatiles emitted from a plant infected with an avirulent PVY strain (FIG. 4c) or of volatiles emitted from a plant infected with a virulent PVY strain (FIG. 4e) exhibited substantial increases in a specific volatile fraction (highlighted by the right arrow), as compared with the chromatogram of volatiles emitted from a non-infected plant (FIG. 4a). The emission of this particular volatile fraction from a plant infected with the virulent PVY further increased two weeks following inoculation (FIG. 4f). Thus, these results indicate that PVY infection of tomato plants caused a differential increase in emission of a specific volatile fraction. In addition, a virulent PVY strain was capable of inducing a higher level of emission of this volatile fraction than an avirulent PVY strain.

Virus infected plants also emitted substantially lower levels of a second specific volatile fraction as compared with non-infected (mock-infected) plants. Accordingly, one week following inoculation, gas chromatograms of headspace volatiles emitted from a plant infected with an avirulent PVY strain (FIG. 4c) and of volatiles emitted from a plant infected with a virulent PVY strain (FIG. 4e) exhibited substantial reductions in a specific volatile fraction (highlighted by the left arrow), as compared with the chromatogram of volatiles emitted from a non infected plant (FIG. 4a). Thus, these results indicate that PVY infection of tomato plants also caused a differential decrease in the emission of specific volatiles.

### Example 2

### Determining Insect Attraction to or Repulsion from Virus Infected Plants

Materials and Methods

Viruses: The Potato Virus Y (PVY) tomato strain and the Cucumber Mosaic Virus (CMV) banana strain were used.

Plants: Virus free tomato (Lycopersicom lycopersicum var. Moneymaker), and tobacco (Nicotiana benthamiana) seedlings were planted in clean pots filled with commercial peat-based potting mixture (Ilanit, Israel) and were maintained in a greenhouse at 18° C.

Virus inoculation: Virus inoculation of plants was performed as described in Example 1 hereinabove.

Insect: Green peach aphids (Myzus persicae) were maintained feeding on virus free mustard plants grown in a growth chamber at 25° C.

Determining insect attraction to or repulsion from plants: The movement of Myzus persicae aphids towards or away from plants was determined in a bioassay using an insect olfactometer system modified from Brikett et al. (2000) (illustrated in FIG. 3). Briefly, aphid alate (winged nymphs) were introduced into a chamber having two tunnels each connecting the chamber to a different plant, either a virus-infected plant or a non-infected plant. The aphids moving in tunnels were periodically trapped and counted enumerated. The differential densities of aphids trapped in each tunnel were indicative of attraction, or repulsion, of the aphids to the volatiles emitted from either plant source.

Results

Myzus persicae aphids (alate) were markedly repulsed from a CMV-infected tobacco plant, 6 weeks post inoculation (FIG. 5). On the other hand, the aphids were clearly attracted to a PVY-infected tomato plant, 4 weeks post inoculation (FIG. 6), but the attraction diminished 4 weeks later (8 weeks post inoculation; FIG. 7). Hence, the results show that virus infection of plants may cause emission of volatiles which can serve as either insect attractants or repellants and that the effect of these volatiles on migrating insects depends on the specific virus-plant-insect combination and the stage of infection.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the present invention.

### REFERENCES CITED

### Additional References are Cited in the Text

1. Birkett M. A., Campbell C. A., Chamberlain K., Guerrieri E, Hick A. J., Martin J. L., Matthes M., Napier J. A., Pettersson J., Pickett J. A., Poppy G. M., Pow E. M., Pye B. J., Smart L. E., Wadhams G. H., Wadhams L. J., Woodcock C. M. (2000). New roles for cis-jasmone as an insect semiochemical and in plant defense. Proc. Natl. Acad. Sci U.S.A. 97: 9329-34.
2. Arimura G. I., Ozawa R., Shimoda T., Nishioka T., Boland W., Takabayashi J. (2000). Herbivory-Induced Volatiles Elicit Defence Genes In Lima Bean Leaves Nature 406: 512-515
3. Dudareva N., Piechulla B., Pichersky E. (1999). Biogenesis of floral volatiles. Hort Rev.
4. Eigenbrode S., Ding H., Shiel P., Berger P. (2002). Volatiles from potato plants infected with potato leafroll virus attract and arrest the virus vector, Myzus persicae (Homoptera:Apphidae) Proc. R. Soc. Lond. 269: 455-460.
5. Gal-On A., Meiri E., Huet H., Hua W. J., Raccah B., Gaba V. (1995). Particle bombardment drastically increases the infectivity of the cloned DNA of zucchin yellow mosaic potyvirus. J. Gen. Virol. 76: 3223-3227.
6. Kessler A. and Baldwin I. T. (2001). Defensive function of herbivore-induced plant volatile emissions in nature. Science. 291: 2141-4.
7. Ozawa R, Arimura G, Takabayashi J, Shimoda T, Nishioka T. (2000). Involvement of jasmonate- and salicylate-related signaling pathways for the production of specific herbivore-induced volatiles in plants. Plant Cell Physiol 41(4): 391-8.
8. Pare P W, Tumlinson J H. (1999). Plant volatiles as a defense against insect herbivores Plant Physiol. 121(2): 325-32.
9. Pickersky E., Raguso R. a., Lewinsohn E., Croteau R. (1994). Floral volatile production in Clarkia (Onagraceae). J. Chem. Ecol. 16: 3053-3065.
10. Pichersky E., J. (2002) The formation and function of plant volatiles: perfumes for pollinator attraction and defense. Current Opinion in Plant Biology 5: 237

1. A method of uncovering a putative insect repellent or attractant comprising identifying volatiles differentially emitted from a plant infected with a virus and identifying at least one of said volatiles thereby uncovering the putative insect repellent or attractant.

2. The method of claim 1, wherein said virus is an insect transmitted virus.

3. The method of claim 1, wherein said virus is a virulent virus.

4. The method of claim 1, wherein said virus is an avirulent virus.

5. The method of claim 2, wherein said virus is acquired by said insect in a persistent manner.

6. The method of claim 2, wherein said virus is acquired by said insect in a non persistent manner.

7. The method of claim 1, wherein said identifying volatiles differentially emitted from said plant infected with said virus is effected by collecting said volatiles emitted from said plant infected with said virus and an identical plant not infected with said virus.

8. The method of claim 7, wherein said collecting is effected by adsorbing said volatiles emitted from said plant and said identical plant to a solid absorbent.

9. The method of claim 8, wherein said collecting is further effected by desorbing said volatiles from said solid absorbent.

10. The method of claim 1, wherein said identifying said at least one of said volatiles is effected by using a gas chromatograph, a gas chromatograph coupled with a mass spectrograph, or a high pressure liquid chromatograph.

11. The method of claim 7, wherein said volatiles differentially emitted from a plant infected with a virus include volatiles emitted at a higher level as compared with said identical plant.

12. The method of claim 7, wherein said volatiles differentially emitted from a plant infected with a virus include volatiles emitted at a lower level as compared with said identical plant.

13. The method of claim 7, wherein said volatiles differentially emitted from a plant infected with a virus include volatiles unique to said plant infected with said virus.

14. The method of claim 7, wherein said collecting said volatiles emitted from said plant infected with said virus is effected at a predetermined time point following infection of said plant with said virus.

15. The method of claim 14, wherein said predetermined time point corresponds to a predetermined titer of said virus in a tissue of said plant.

16. The method of claim 1, further comprising monitoring a behavior of a plurality of insects exposed to said at least one of said volatiles.

17. The method of claim 16, wherein said monitoring is effected by enumerating said plurality of insects attracted or repelled by said at least one of said volatiles.

18. The method of claim 17, wherein said enumerating is effected by trapping.

19. The method of claim 17, wherein said monitoring is effected by using an insect olfactometer.

20. The method of claim 1, further comprising isolating said at least one of said volatiles.

21. A method of uncovering a putative insect repellent or attractant comprising:
(a) infecting a plant with a virus;
(b) identifying volatiles differentially emitted from said plant infected with said virus as compared to a non-infected plant at a time point following said step of said infecting said plant with said virus;
(c) identifying at least one of said volatiles thereby uncovering the putative insect repellent or attractant.

22. The method of claim 21, wherein said predetermined time point corresponds to a predetermined titer of said virus in a tissue of said plant.
